(19) United States
(12) Patent Application Publication
(10) Pub. No.: US 2024/0386223 A1
(43) Pub. Date: Nov. 21, 2024

(54) SYSTEMS, METHODS, AND TAGS FOR WEAPON DETECTION

(71) Applicant: Wenjuan ZOU, Redmond, WA (US)

(72) Inventor: Wenjuan ZOU, Redmond, WA (US)

(21) Appl. No.: 18/199,754

(22) Filed: May 19, 2023

(51) Int. Cl. G06K 7/10; G06K 19/077

(52) U.S. Cl. CPC G06K 7/10366; G06K 19/07758

(57) ABSTRACT

Embodiments of the disclosure provide systems, methods, and tags for detecting weapons. The system includes a detector and a receiver which is embedded in a weapon. The detector is a radio-frequency identification (RFID) detector. The receiver is an RFID tag. The detector includes an RFID reader, a detector antenna, and an alarm. The RFID tag includes a chip and a tag antenna. The RFID tag stores information about the weapon. The alarm is triggered in response to detecting the receiver by the detector.

### TECHNICAL FIELD

The present disclosure relates to weapon detection, and more particularly, to weapon detection using electromagnetic signals.

### BACKGROUND

Weapons are detected in some public places for safety purposes. For example, guns and other dangerous weapons are screened at airports using a variety of devices, such as metal detectors, millimeter wave machines, backscatter X-ray and cabinet X-ray machines.

Metal detectors identify metal objects using magnetic fields. Some metal detectors use non-ionizing radiation. Non-ionizing radiation has enough energy to move atoms in a molecule around or cause them to vibrate, but not enough to remove electrons from atoms. Millimeter wave machines use non-ionizing radiofrequency waves to detect weapons. Millimeter wave machines can show hidden threats such as guns and knives. In airports, both metal detectors and millimeter wave machines use low energy, non-ionizing radiation to send energy across scanned surfaces. Backscatter X-ray machines use very low energy X-rays that are reflected back to the machines. Backscatter X-ray machines, such as backscatter passenger scanners are used to detect hidden weapons, tools, liquids, currency etc. Cabinet X-ray machines are used to screen luggage and carry-on items of passengers. Cabinet X-ray machines are equipped with thick walls of the enclosed cabinet and lead curtains at the entry and exit points of the cabinets to keep radiation from escaping.

However, current weapon detectors require passengers and luggage to be detected one at a time. The detection process is time-consuming and not productive. Therefore, current weapon detectors are not suitable for public places with high traffic and fast-moving crowds, such as schools, hospitals, shopping malls, etc. Moreover, backscatter scanning devices meant for airline passengers have caused controversies focused on both the privacy issues of the scans and the safety of the devices themselves. Furthermore, X-ray radiation can bring a risk of health issues and cannot be used frequently on human beings.

Radio-frequency identification (RFID) uses electromagnetic fields to automatically identify and track RFID tags attached to objects. An RFID system includes an RFID reader and RFID tags. When triggered by an electromagnetic interrogation pulse from a nearby RFID reader device, the RFID tag transmits digital data, for example, an identifying inventory number, back to the RFID reader. RFID technology has been widely used in payment systems or toll roads, animal tracking, etc. RFID technology has advantages of accuracy, efficiency, and security. Additionally, RFID radiation does not cause harmful effects on human beings like X-rays.

Embodiments of the present disclosure address the problems of privacy, health issues, and inefficiency by providing systems, methods, and tags for weapon detection using RFID technology.

### SUMMARY

Embodiments of the disclosure provide a weapon detection system using RFID technology. The weapon detection system includes a detector and a receiver. The detector is an RFID detector and configured to send Radio Frequency (RF) signals. The receiver is an RFID tag and configured to receive RF signals from the detector and return RF signals to the detector. The RFID tag is embedded in a weapon and stores information about the weapon.

Embodiments of the disclosure also provide a method for detecting weapons using RFID technology. The method includes sending RF signals by an RFID detector; receiving, by an RFID tag, RF signals from the RFID detector; returning, by the RFID tag, RF signals to the RFID detector; and triggering an alarm in response to detecting the RFID tag by the RFID detector. The RFID tag is embedded in a weapon and stores information about the weapon.

Embodiments of the disclosure further provide an RFID tag for detecting weapons. The RFID tag includes a chip and a tag antenna. The RFID tag is embedded in a weapon and stores information about the weapon.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system for weapon detection, according to embodiments of the disclosure.

FIG. 2A illustrates a block diagram of an exemplary RFID detector for weapon detection, according to embodiments of the disclosure.

FIG. 2B illustrates a block diagram of an exemplary RFID tag, according to embodiments of the disclosure.

FIG. 3 illustrates a schematic diagram of an exemplary weapon embedded with an RFID tag, according to embodiments of the disclosure.

FIG. 4 illustrates a flow chart of an exemplary method for detecting weapons, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

A system using magnetic fields, radiofrequency waves, or X-rays may be used to detect weapons in public places. For example, airports use metal detectors, millimeter wave machines, or X-ray machines to help identify weapons such as guns. Due to the slow response of current detection devices, passengers and luggage are required to go through the detection devices one after another. This results in a clog in the security line. In addition, X-rays can damage the health of human beings. Meanwhile, privacy cannot be protected when passengers are exposed to some of the above-mentioned devices.

Embodiments of the present disclosure provide weapon detection systems by using electromagnetic technology. An exemplary system may include a detector and a receiver. The detector may send electromagnetic signals. The receiver may receive electromagnetic signals from the detector and return electromagnetic signals to the detector. The receiver may be embedded in a weapon.

In one example, the electromagnetic signals may be Radio Frequency (RF) signals. The detector may be an RFID detector. The receiver may be an RFID tag which may store information about the weapon, for example, the make, model, manufacturer, and serial number. The RFID detector may comprise an RFID reader, a detector antenna, and an alarm. The RFID tag may comprise a chip and a tag antenna. The combination of RFID reader and RFID tag can improve the efficiency of identifying weapons. Meanwhile, RFID signals may cause less damage to the health of human beings compared to X-rays. Additionally, privacy of human beings will not be violated under the RFID detection systems.

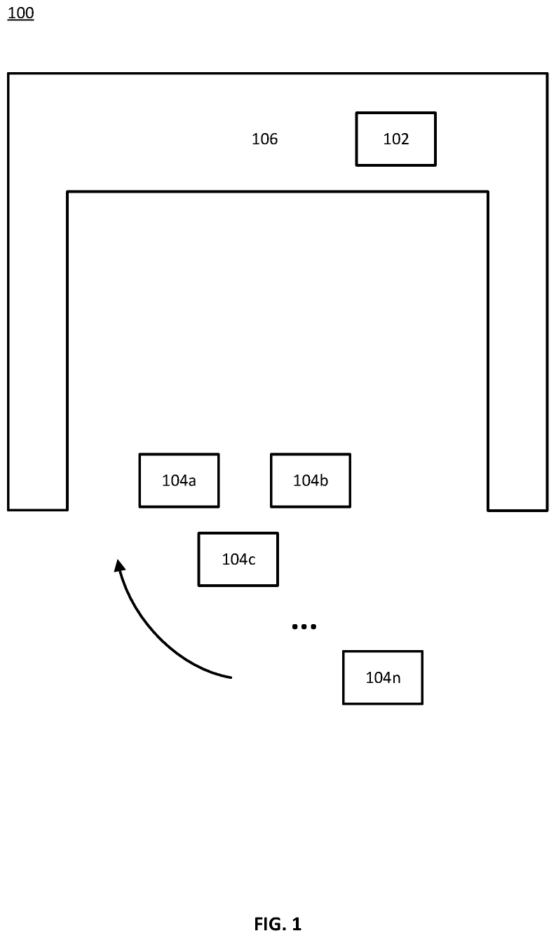

FIG. 1 illustrates a block diagram of an exemplary detecting system 100 for detecting weapons, according to embodiments of the disclosure. As illustrated in FIG. 1, detecting system 100 may comprise a detector 102 and objects 104 (i.e., 104a, 104b, 104c, . . . , 104n). Detector 102 may use electromagnetic signals. In some embodiments, detector 102 may be affixed to doorframe 106 of an entrance of a building, as shown in FIG. 1. It is contemplated that the manners in which detector 102 can be equipped at the entrance of buildings are not limited by the example shown in FIG. 1 and may be modified depending on the designs of the entrance of buildings to achieve the desirable detecting purposes. For example, detector 102 may be equipped on the ground of an entrance of a building.

It is contemplated that the ways in which objects 104 may go through the entrance of buildings are not limited by the example shown in FIG. 1. For example, a plurality of objects 104 may go through detector 102 sequentially. For another example, a plurality of objects 104 may go through detector 102 simultaneously.

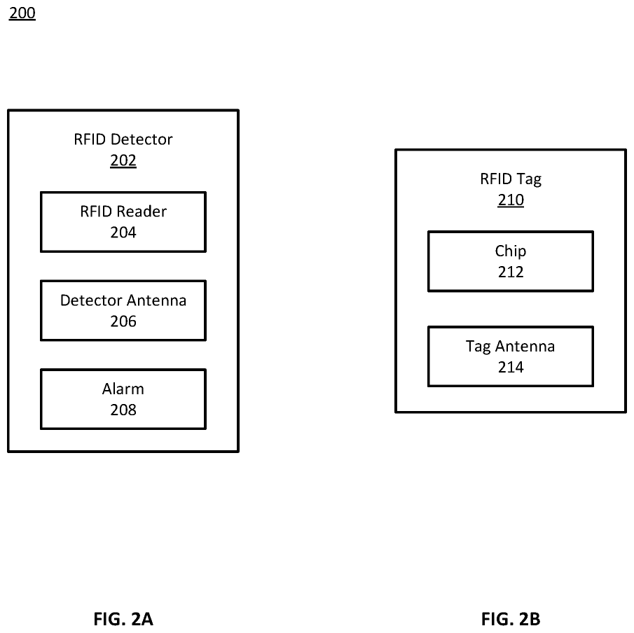

FIG. 2A illustrates a block diagram 200 of an exemplary RFID detector 202, such as detector 102 used in detecting system 100. FIG. 2B illustrates a block diagram 200 of an exemplary RFID tag 210, which may be affixed to objects 104 in detecting system 100. RFID detector 202 may send Radio Frequency (RF) energy (i.e., RF signals) to RFID tag 210. RFID tag 210 may return RF signals to RFID detector 202.

RFID detector 202 may comprise an RFID reader 204, a detector antenna 206, and an alarm 208. RFID reader 204 may decode RF signals. Detector antenna 206 may send and transmit RF signals. Alarm 208 may be triggered when RFID tag 210 is detected by RFID detector 202. RFID tag 210 may comprise a chip 212 and a tag antenna 214. Chip 212 and tag antenna 214 may be temporarily powered by energy from RFID reader 204. Tag antenna 214 may receive and transmit the RF signals from RFID reader 204. Tag antenna 214 may collect energy and channel the energy to chip 212 to turn it on. Chip 212 may store information about the weapon to which RFID tag 210 is embedded.

In some embodiments of the present disclosure, the frequency of the RF signals may range from 3 MHz to 30 MHz. For example, the frequency may be 13.56 MHz. In other embodiments, frequency of the RF signals may range from 300 MHz to 3 GHZ. For example, the frequency may range from 840 MHz to 960 MHz. In another example, the frequency may range from 900 MHz to 915 MHz.

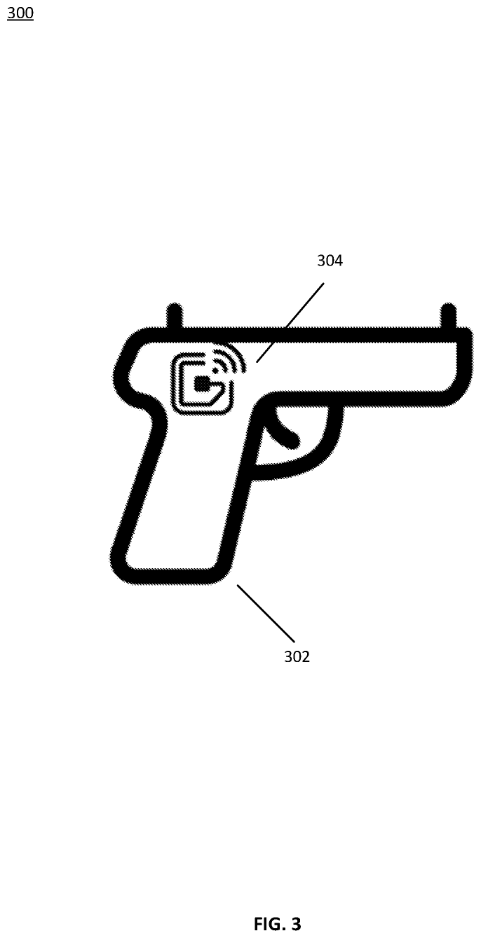

FIG. 3 illustrates a schematic diagram 300 of an exemplary weapon 302 embedded with an RFID tag 304, such as RFID tag 210 in FIG. 2B, according to embodiments of the disclosure. RFID tag 304 may store information about the weapon, for example, the make, model, manufacturer, and serial number. In some embodiments, RFID tag 304 may be embedded on the outer surface of weapon 302. In other embodiments, RFID tag 304 may be embedded on the inner surface of weapon 302. The layout illustrated in FIG. 3 is only for illustrative purposes. It is contemplated that the style of weapon 302 may not be limited by the example shown in FIG. 3. For example, weapon 302 may be a pistol, a revolver, a rifle, a shotgun, a machine gun, etc.

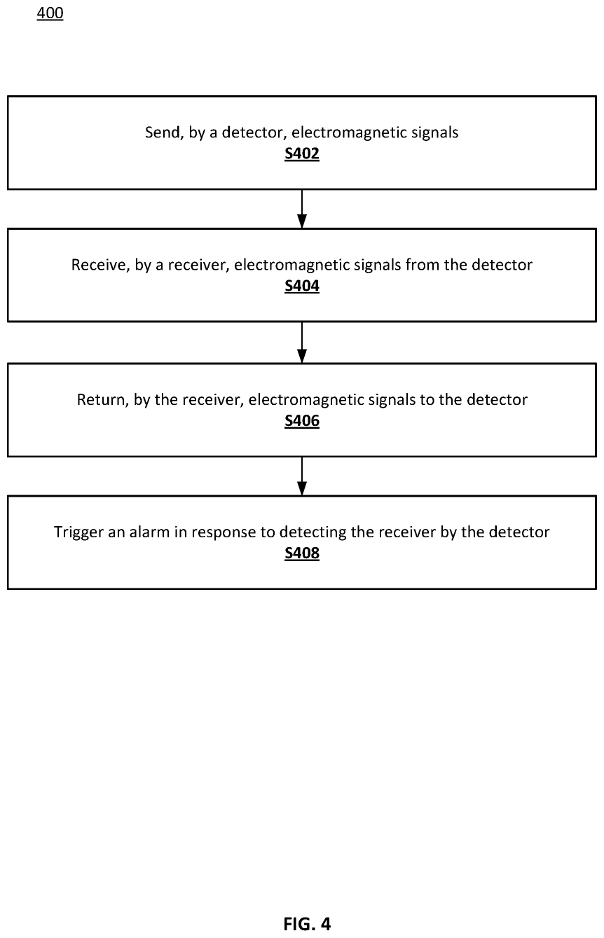

FIG. 4 illustrates a flow chart of an exemplary method 400 for detecting weapons, according to embodiments of the disclosure. In some embodiments, method 400 may be implemented by detecting system 100. It is to be appreciated that some of the steps in method 400 may be optional, while additional steps may be inserted. Further, some of the steps of method 400 may be performed simultaneously, or in an order different from the example shown in FIG. 4.

Consistent with some embodiments, in step S402, a detector (e.g., detector 102) may send electromagnetic signals. In step S404, a receiver that is affixed to an object (e.g., objects 104) may receive electromagnetic signals from the detector. In step S406, the receiver may return electromagnetic signals to the detector.

In some embodiments, the electromagnetic signals may be Radio Frequency (RF) signals. The detector may be an RFID detector (e.g., RFID detector 202). The receiver may be an RFID tag (e.g., RFID tag 210) embedded in a weapon. The RFID detector may send energy (i.e., RF signals) to the RFID tag. The RFID tag may return RF signals to the RFID detector. RFID detector 202 may include an RFID reader (e.g., RFID reader 204), a detector antenna (e.g., detector antenna 206), and an alarm (e.g., alarm 208). The RFID reader may decode RF signals. The detector antenna may send and transmit RF signals. The RFID tag may comprise a chip (e.g., chip 212) and a tag antenna (e.g., tag antenna 214). The chip and tag antenna may be temporarily powered by energy from the RFID reader. The tag antenna may receive and transmit the RF signals from the RFID reader. The tag antenna may collect energy and channel the energy to the chip to turn it on. The chip may store information about the weapon in which the RFID tag is embedded.

In step S408, an alarm (e.g., alarm 208) may be triggered when a target object (e.g., object 104b) is detected. The target object may comprise an RFID tag (e.g., RFID tag 210). The alarm may be set in a variety of designs. For example, the alarm may be a flashlight, a siren, or a combination of flashlight and siren.

In some embodiments of the present disclosure, the frequency of the RF signals may range from 3 MHz to 30 MHz. For example, the frequency may be 13.56 MHz. In other embodiments, the frequency of the RF signals may range from 300 MHz to 3 GHZ. For example, the frequency may range from 840 MHz to 960 MHz. In another example, the frequency may range from 900 MHz to 915 MHz.

It will be apparent to those skilled in the art that various modifications and variations can be made to the disclosed systems and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A system for detecting weapons, comprising:
a detector configured to send electromagnetic signals; and
a receiver configured to receive electromagnetic signals from the detector and return electromagnetic signals to the detector,
wherein the receiver is embedded in a weapon;
wherein the electromagnetic signals are Radio Frequency (RF) signals, the detector is a radio-frequency identification (RFID) detector, and the receiver is an RFID tag that stores information about the weapon;
wherein the RFID detector comprises an RFID reader, a detector antenna, and an alarm; and the RFID tag comprises a chip and a tag antenna;
wherein the alarm is triggered when the RFID detector detects the RFID tag embedded in the weapon; and
wherein the RFID detector is equipped at entrances of buildings.

2.-3. (canceled)

4. The system of claim 1, wherein:
a frequency of the RF signals ranges from 3 MHz to 30 MHz.

5. The system of claim 1, wherein:
a frequency of the RF signals ranges from 300 MHz to 3 GHz.

6. The system of claim 1, wherein:
the RFID tag is embedded on an outer surface of the weapon.

7. The system of claim 1, wherein:
the RFID tag is embedded on an inner surface of the weapon.

8. A method for detecting weapons, comprising:
sending, by a detector, electromagnetic signals;
receiving, by a receiver, electromagnetic signals from the detector;
returning, by the receiver, electromagnetic signals to the detector; and
triggering an alarm in response to detecting the receiver by the detector,
wherein the receiver is embedded in a weapon;
wherein the electromagnetic signals are Radio Frequency (RF) signals, the detector is a radio-frequency identification (RFID) detector, and the receiver is an RFID tag that stores information about the weapon;
wherein the RFID detector comprises an RFID reader, a detector antenna, and an alarm; and the RFID tag comprises a chip and a tag antenna; and
wherein the RFID detector is equipped at entrances of buildings.

9.-10. (canceled)

11. The method of claim 8, wherein:
a frequency of the RF signals ranges from 3 MHz to 30 MHz.

12. The method of claim 8, wherein:
a frequency of the RF signals ranges from 300 MHz to 3 GHz.

13. The method of claim 8, wherein:
the RFID tag is embedded on an outer surface of the weapon.

14. The method of claim 8, wherein:
the RFID tag is embedded on an inner surface of the weapon.

15.-20. (canceled)
